(19) United States
(12) Patent Application Publication
(10) Pub. No.: US 2023/0001516 A1
(43) Pub. Date: Jan. 5, 2023

(54) PLASTIC PROCESSING METHOD

(71) Applicant: AERO PUMP GMBH, Hochheim/Main (DE)

(72) Inventor: Sebastian ROTHER, Mainz (DE)

(73) Assignee: AERO PUMP GMBH, Hochheim/Main (DE)

(21) Appl. No.: 17/854,082

(22) Filed: Jun. 30, 2022

(30) Foreign Application Priority Data
Jul. 1, 2021 (DE) 10 2021 117 021.4

(51) Int. Cl. B23K 26/382; B23K 26/0622; B23K 26/06

(52) U.S. Cl. CPC B23K 26/389; B23K 26/0622; B23K 26/0665; B23K 2103/42

(57) ABSTRACT

A method for processing a plastic workpiece having a first side and a second side opposite the first side using laser ablation and a nozzle body produced according to the method. The method includes advancing a laser beam into the plastic workpiece from outside of the plastic workpiece and through the first side to at least partially penetrate the plastic workpiece, and evaporating at least a portion of the plastic workpiece with the laser beam starting from the second side.

### CROSS-REFERENCE TO RELATED APPLICATION

This application claims priority under 35 U.S.C. § 119(a) to German Application No. 10 2021 117 021.4 filed Jul. 1, 2021, the disclosure of which is expressly incorporated by reference herein in its entirety.

### BACKGROUND

### 1. Field of the Invention

The present invention relates to a method for processing a highly transparent plastic workpiece having a first side and a second side using laser ablation, wherein a laser arrangement emits a laser beam, with the laser beam advancing into the plastic workpiece from the outside through the first side.

### 2. Discussion of Background Information

Laser ablation, also called laser evaporation, denotes the removal of material from a surface by bombardment with a laser beam. A portion of the surface is thereby evaporated by the laser radiation or laser beam. Depending on the characteristics of the laser beam and of the material of the workpiece, a generation of plasma also occurs, as a result of which material on the surface evaporates and is consequently removed.

A laser arrangement describes an arrangement by which a laser beam is generated, guided, and emitted. The laser arrangement thus comprises a laser generating apparatus, a laser guiding arrangement, and a laser guiding device.

In known plastic processing methods using laser ablation, the laser beam advances into the plastic workpiece through the top side and evaporates material on the top side of the plastic workpiece. The evaporated material escapes into the surrounding environment from. the top side. in this case, it can occur that the evaporated material interacts with the laser beam, and thus affects the laser beam. This results in a potential source of error, which should be avoided. Accordingly, when designing the geometry that is to be produced, care must be taken that the evaporated material does not interact with the laser beam. This results in a number of design guidelines through which the design freedom of the workpiece is limited.

### SUMMARY

Embodiments are directed to a plastic processing method with a good design freedom.

Accordingly, embodiments include a method of the type named at the outset in which the laser beam at least partially penetrates the plastic workpiece. The laser beam evaporates a portion of the plastic workpiece starting from the second side.

In the method according to the invention, the laser beam at least partially penetrates the plastic workpiece, wherein the laser beam evaporates a portion of the plastic workpiece starting from the second side. The laser beam thus penetrates the plastic workpiece partially, with no material being evaporated on the first side. The second side is thereby arranged such that the laser beam can reach the second side from the first side. For this purpose, the first side is arranged essentially opposite of the second side, for example.

This arrangement results in the evaporated material not being able to interact with the laser beam, so that the laser beam can evaporate material in an unhindered and repeatable manner. This affords a high degree of design freedom.

Furthermore, a plastic structure that is located around an evaporated region is altered such that said structure is no longer transparent and is thus impermeable by the laser beam. The plastic structure becomes “dead” in this region. As a result, the laser beam can no longer advance into the plastic workpiece from the outside through the altered plastic structure. With the method according to the invention, the plastic workpiece is processed in the direction of the first side starting from the second side, so that starting from unaltered plastic structure, the laser beam reaches a portion of the plastic workpiece that is to be processed. As a result, there is always transparent, unaltered plastic between the first side and the portion of the plastic workpiece that is to be processed. The plastic workpiece is thus processed against a direction of the laser beam. In this manner, it is possible to write 3D structures of any kind, provided that evaporated plastic can escape in the direction of the second side. A high degree of design freedom is thus achieved.

Preferably, the evaporated plastic escapes towards the outside. The plastic evaporated by the laser beam escapes from the plastic workpiece to a surrounding environment of the plastic workpiece. The direction “towards the outside” thereby corresponds, for example, to a direction which faces away from the workpiece and/or the laser beam. In this manner, an interaction between the laser beam and the evaporated portion of the plastic workpiece is avoided. This results in a good process reliability. In addition, a good design freedom is achieved.

Preferably, the portion of the plastic workpiece evaporates in the region of a focal point. The focal point describes a point at which the laser beam is focused. Therefore, a high power density occurs at this point, which results in an evaporation of the plastic workpiece in the region of the focal point. Furthermore, energy is introduced in this region in a targeted manner, so that a heating of the surrounding portion of the plastic workpiece is avoided. A change in the morphology of the plastic workpiece in the region around the focal point is thus avoided, so that material properties of the plastic workpiece remain unchanged. Accordingly, an aftertreatment of the plastic workpiece can be dispensed with, which results in good productivity and efficiency.

Preferably, undercuts and/or deep-hole geometries are produced using the method. Previous design possibilities for the laser ablation methods described in the introduction are expanded to include deep-hole geometries and undercuts, so that in addition to deep-hole geometries and undercuts, other geometries can also be produced. Deep-hole geometries describe, for example, geometries with a length or depth that is significantly larger than the diameter thereof. Thus, the length corresponds to at least three times the diameter, for example. Undercuts describe geometries in which unprocessed material is located along a line perpendicular to a plastic surface between the plastic surface and. a portion that is to be processed. Examples of an undercut include a helix geometry, spiral-shaped geometry, channels not arranged at a 90° angle to the plastic surface, or the like. Because the evaporated portion of the plastic workpiece can escape in the direction of the surrounding environment, the evaporated portion of the plastic workpiece does not interact with the laser beam, so that there is no need to take the evaporated portion of the plastic workpiece into consideration in the design engineering and the design freedom is thus enhanced.

Preferably, nozzle bodies are produced using the method. Nozzle bodies, which are used for spray nozzles or the like for example, require intricate geometries, for example, which can be satisfied and produced in a precise manner with the described method. Examples of nozzle bodies include dual-stream nozzles, hollow-cone nozzles, or single-stream nozzles. As a result, a spray pattern of the nozzle body is improved and a design freedom of the nozzle bodies is increased.

The laser arrangement preferably emits a high-energy pulse. Through the high-energy pulse, energy is introduced into the plastic workpiece in the region of the focal point. As a result, material in the region of the focal point is evaporated abruptly, so that an introduction of heat into the material bordering the focal point is minimized. The regions of the plastic workpiece bordering the focal point are thus not morphologically affected. Accordingly, the plastic workpiece retains desired material properties on the unprocessed areas, so that an aftertreatment of the plastic workpiece can be avoided. This results in good efficiency.

Preferably, the laser beam has a focal point, the dimensions of which lie in the range of 0.001 mm to 0.25 mm. Because the focal point has dimensions in the range of 0.001 mm to 0.25 mm, geometries with a resolution of 0.001 mm to 0.25 mm can be produced. Due to this precise resolution of the geometries, it is possible to produce even small, fine geometries that are below a resolution of injection molding processes, for example. A good design freedom is thus achieved.

The focal point is preferably a first focal point, wherein at least a second focal point lies adjacent to the first focal point. Through this focal point arrangement, it is possible to construct a geometry, or to evaporate a portion of the plastic workpiece, such that the evaporated portion of a second focal point can escape in the direction of the already-evaporated portion of the first focal point. The laser beam is thereby first focused at the first focal point and is subsequently focused at the second focal point, so that a single focal point is focused at a time. Alternatively, the laser beam can be emitted continuously, so that a focal point of the continuously emitted laser beam is transferred from a first point to a second point without being refocused. The ability to also produce undercuts or the like thus becomes possible.

Preferably, at least the first focal point and the second focal point lie on a predefined route. The route can thereby comprise additional focal points. Thus, a sequence of portions to be evaporated from the different focal points can be moved through in succession, whereby a desired geometry can be produced. The focal points are moved through in a chronological sequence, so that one focal point is focused at a time. Alternatively, the laser beam can be continuously emitted such that it is focused on one focal point and can be moved along the route. The route can thereby be planned and defined in advance, in order to achieve optimum efficiency. Furthermore, evaporated. material can escape through previously removed and/or evaporated regions.

Preferably, a nozzle body is produced using a method according to the invention, wherein the nozzle body comprises, at least in part, highly transparent plastic. With the method, channels or recesses can be produced which, for example, have oblong-hole geometries, undercuts, or other geometries. The design freedom of nozzle bodies is thereby increased.

The nozzle body is preferably an atomizing nozzle. An atomizing nozzle is characterized in that the liquid is pressed through at least one channel and is subsequently atomized. The channel is designed differently depending on the requirements for the atomizing nozzle, with the channel also needing, to be adapted to the liquid being atomized, for example. Through the use of the method according to the invention, it is possible, for example, to create at least one undercut that is advantageous for the atomization of the liquid.

The nozzle body preferably comprises a filter arrangement. The filter arrangement is formed by a number of channels, wherein the channels should be smaller than phases in the liquid that are to be filtered. For this purpose, the filter arrangement should he composed of at least one channel, for example. This channel can be produced using the present method.

Preferably, the nozzle body comprises at least one channel which is cylindrical and has a largest diameter essentially between 0.001 mm and 0.25 mm. Cylindrical thereby describes a prism-shaped geometry in which a cross sectional area is constant along a defined length. With the method, it is possible to produce just such a cylindrical channel with the dimensions indicated. This affords a high degree of design freedom of the nozzle body.

Embodiments are directed to a method for processing a plastic workpiece having a first side and a second side opposite the first side using laser ablation. The method includes advancing a laser beam into the plastic workpiece from outside of the plastic workpiece and through the first side to at least partially penetrate the plastic workpiece; and evaporating at least a portion of the plastic workpiece with the laser beam starting from the second side.

According to embodiments, the evaporated plastic can escape toward the outside of the plastic workpiece.

In accordance with other embodiments, the at least a portion of the plastic workpiece can evaporate in a region of a focal point of the laser beam.

In other embodiments, at least one of undercuts or deep-hole geometries may be producible in the plastic workpiece.

According to still other embodiments, the plastic workpiece may be processed to produce a nozzle body. The at least one portion of the plastic workpiece evaporated by the laser beam can form at least one channel of the nozzle body. Further or alternatively, the at least one portion of the plastic workpiece evaporated by the laser beam may form a filter arrangement of the nozzle body.

In accordance with embodiments, the method can further include emitting the laser beam from a laser arrangement. The laser arrangement can emit a high-energy pulse.

In other embodiments, the laser beam can have a focal point with dimensions in a range of 0.001 mm to 0.25 mm.

According to other embodiments, the focal point may include a first focal point and at least a second focal point that lies adjacent to the first focal point. Further, at least one of the first focal point and the at least one second focal point may lie on a predefined route.

In embodiments, the plastic workpiece may include a highly transparent plastic workpiece.

According to embodiments, the method may also include focusing a focal point of the laser beam on the second side and moving the focal point of the laser beam in a direction from the second side toward the first side. The method may also include moving the focal point of the laser crosswise to the direction from the second side to the first side.

In still other embodiments, the method may further include additional processing of the plastic workpiece, where the additional processing starts from the first side.

In accordance with embodiments, a nozzle body can be produced according to any of the above-described embodiments of the method. Further, the plastic workpiece can include, at least in part, a highly transparent plastic.

According to other embodiments, the nozzle body can he an atomizing nozzle body.

In still other embodiments, the nozzle body may include a filter arrangement.

In accordance with still yet other embodiments, the nozzle body can include at least one channel that is cylindrical with a largest diameter essentially between 0.001 mm and 0.25 mm.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic view of a laser arrangement and a plastic workpiece;

FIG. 2 shows a schematic view of the laser arrangement with a plastic workpiece that has already been processed;

FIG. 3 shows a laser arrangement with another processed plastic workpiece;

FIG. 4 shows a laser arrangement and a plastic workpiece with a deep hole;

FIG. 5 shows a schematic illustration of a Rayleigh nozzle body;

FIG. 6 shows a schematic illustration of a filter arrangement.

### DETAILED DESCRIPTION

The particulars shown herein are by way of example and. for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

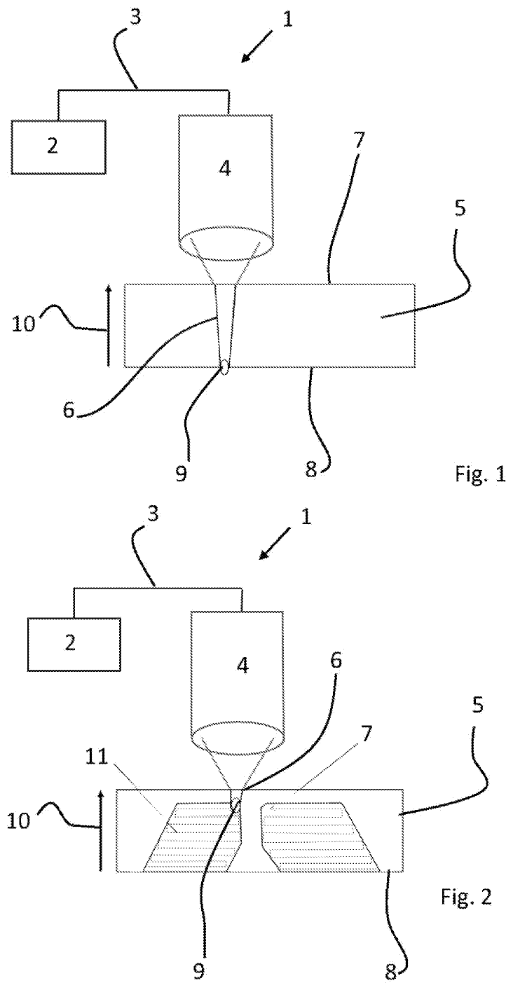

In FIGS. 1 through 4, one laser arrangement 1 is illustrated in each case with a laser generating device 2, a laser guiding arrangement 3, and an objective lens 4. In addition, one transparent plastic workpiece 5 is illustrated in each case.

The laser generating device 2 generates a laser beam 6, which is guided to the objective lens 4 by the laser guiding arrangement 3. The laser beam 6 is emitted starting from the objective lens 4. The laser beam 6 advances into the plastic workpiece 5 through a first side 7. There, the laser beam 6 penetrates the plastic workpiece 5 until it is focused at a focal point 9 on a second side 8 of the plastic workpiece 5. A direction of travel 10 of the focal point 9 is thereby provided essentially towards the first side 7 starting from the second side 8.

FIG. 2 shows a plastic workpiece 5 that has already been partially processed, wherein the focal point 9 is guided along a route 11. The evaporated plastic can thereby escape without interacting with the laser beam 6. Undercuts can also be produced.

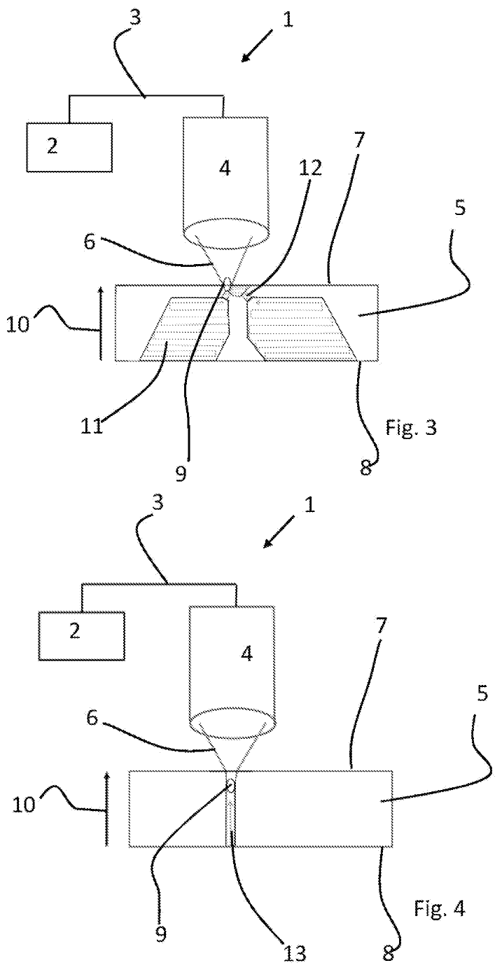

In FIG. 3, a plastic workpiece 5 is illustrated which has been processed both starting from the second side 8 and also from the first side 7. For this purpose, material is first evaporated starting from the second side 8, in order to then form a channel 12. As a final step, the remaining geometry is formed starting from the first side 7.

FIG. 4 shows a plastic workpiece 5 in which a deep-hole geometry 13 is formed. For this purpose, the focal point 9 is moved to the second side 8, in order to then be moved in the direction of the direction of travel 10. The evaporated plastic can escape through an already-processed portion of the plastic workpiece 5. The evaporated plastic thus does not interact with the laser beam 6, so that the deep-hole geometry 13 can be created as a cylindrical shape.

With the method described above, nozzle bodies and filter arrangements, for example, can be produced.

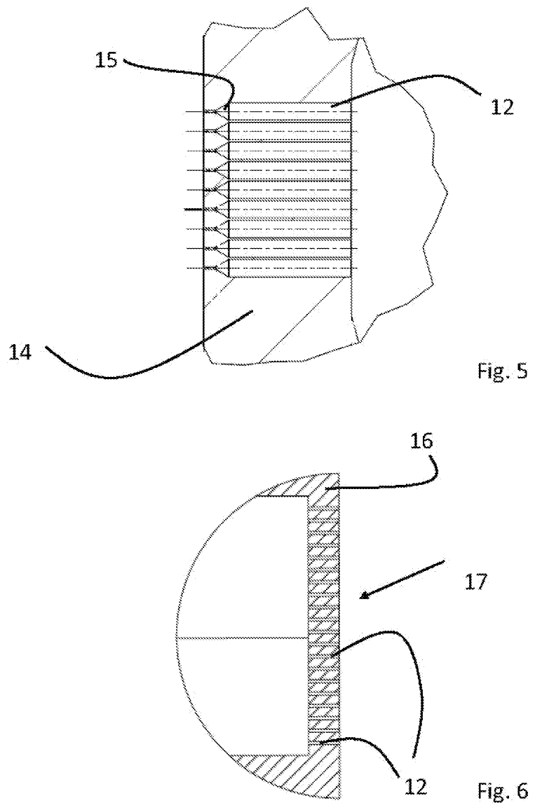

A section of an exemplary Rayleigh nozzle body 14 is illustrated in FIG. 5. The Rayleigh nozzle body 14 comprises a plurality of channels 12, wherein the channels 12 are tapered by a funnel-shaped geometry 15. The channels 12, with the exception of the funnel-shaped geometry 15, thereby have a cylindrical, deep-hole geometry.

In FIG. 6, a schematic section of a nozzle body 16 is illustrated with a filter arrangement 17. The filter arrangement 17 comprises a plurality of channels 12 which each have a cylindrical, deep-hole geometry. The filter arrangement 17 is located upstream of a nozzle in order to filter out ultra-fine particles and thus prevent a clogging of the nozzle.

It is noted that the foregoing examples have been provided merely for the purpose of explanation and are in no way to be construed as limiting of the present invention. While the present invention has been described with reference to an exemplary embodiment, it is understood that the words which have been used herein. are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMERALS

1 Laser arrangement
2 Laser generating device
3 Laser guiding arrangement
4 Objective lens
5 Plastic workpiece
6 Laser beam
7 First side
8 Second side
9 Focal point
10 Direction of travel
11 Route
12 Channel
13 Deep-hole geometry
14 Rayleigh nozzle body
15 Funnel-shaped geometry
16 Nozzle body
17 Filter arrangement

What is claimed:

1. A method for processing a plastic workpiece having a first side and a second side opposite the first side using laser ablation, comprising:
advancing a laser beam into the plastic workpiece from outside of the plastic workpiece and through the first side to at least partially penetrate the plastic workpiece; and
evaporating at least a portion of the plastic workpiece with the laser beam starting from the second side.

2. The method according to claim 1, wherein the evaporated plastic escapes toward the outside of the plastic workpiece.

3. The method according to claim 1, wherein the at least a portion of the plastic workpiece evaporates in a region of a focal point of the laser beam.

4. The method according to claim 1, wherein at least one of undercuts or deep-hole geometries are producible in the plastic workpiece.

5. The method according to claim 1, wherein the plastic workpiece is processed to produce a nozzle body.

6. The method according to claim 5, wherein the at least one portion of the plastic workpiece evaporated by the laser beam forms at least one channel of the nozzle body.

7. The method according to claim 5, wherein the at least one portion of the plastic workpiece evaporated by the laser beam forms a filter arrangement of the nozzle body.

8. The method according to claim 1, further comprising emitting the laser beam from a laser arrangement.

9. The method according to claim 8, wherein the laser arrangement emits a high-energy pulse.

10. The method according to claim 1., wherein the laser beam has a focal point with dimensions in a range of 0.001 mm to 0.25 mm.

11. The method according to claim 1, wherein the focal point comprises a first focal point and at least a second focal point that lies adjacent to the first focal point.

12. The method according to claim 11, wherein at least one of the first focal point: and the at least one second focal point lies ton a predefined route.

13. The method according to claim 1., wherein the plastic workpiece comprises a highly transparent plastic workpiece.

14. The method according to claim 1, further comprising focusing a focal point of the laser beam on the second side and moving the focal point of the laser beam in a direction from the second side toward the first side.

15. The method according to claim 14, further comprising moving the focal point of the laser crosswise to the direction from the second side to the first side.

16. The method according to claim 1, further comprising additional processing of the plastic workpiece, wherein the additional processing starts from the first side.

17. A nozzle body produced according to the method of claim 1, wherein the plastic workpiece comprises, at least in part, a highly transparent plastic.

18. The nozzle body according to claim 17, wherein the nozzle body is an atomizing nozzle body.

19. The nozzle body according to claim 17, wherein the nozzle body comprises a filter arrangement.

20. The nozzle body according to claim 17, wherein the nozzle body comprises at least one channel that is cylindrical with a largest diameter essentially between 0.001 mm and 0.25 mm.
